(19) United States
(12) Patent Application Publication
(10) Pub. No.: US 2026/0084173 A1
(43) Pub. Date: Mar. 26, 2026

(54) VEHICLE PAINTING MACHINE

(71) Applicant: ABB SCHWEIZ AG, Baden (CH)

(72) Inventor: Kuniharu Yamauchi, Tokyo (JP)

(21) Appl. No.: 19/303,923

(22) Filed: Aug. 19, 2025

(30) Foreign Application Priority Data
Sep. 20, 2024 (JP) 2024163974

(51) Int. Cl. B05B 15/52

(52) U.S. Cl. CPC B05B 15/52

(57) ABSTRACT

A vehicle painting machine includes a supply line for supplying a paint toward an inkjet-type painting head; a bypass flow path which causes the paint in the supply line to bypass the painting head; a switching unit for switching the paint from the supply line between head flow paths and the bypass flow path; a supply unit for selectively supplying a washing liquid and air to the supply line; and a washing control unit for controlling the switching unit and the supply unit to wash the painting head, and the washing control unit washes the painting head with the washing liquid in a gas-liquid mixed state by supplying the air in a state of supply to the bypass flow path wherein the supply line is filled with the washing liquid, and causing the washing liquid to flow by switching a first three-way valve to the head flow path side in a state in which the air and the washing liquid have formed two layers along a flow direction.

### TECHNICAL FIELD

The present invention relates to a vehicle painting machine.

### BACKGROUND ART

There are known painting machines for painting automobile vehicle bodies (referred to below simply as “vehicle bodies”) using inkjet technology. Inkjet-type vehicle painting machines comprise a painting head which ejects a predetermined quantity of paint droplets toward the vehicle body from each of a plurality of nozzles provided on a nozzle-forming face (ejection face).

Patent Document 1 describes an inkjet-type vehicle painting machine wherein a washing operation is performed by flushing the painting head with a washing liquid. Possible methods for better washing of the painting head include a method employing a washing liquid mixed with high-pressure compressed air, and a method employing a washing liquid containing microbubbles generated by high pressure.

### PRIOR ART DOCUMENTS

### Patent Documents

[Patent Document 1] JP 7241955 B1

### SUMMARY OF THE INVENTION

### Problems to be Solved by the Invention

In structural terms, however, a painting head of an inkjet-type vehicle painting machine has a low pressure-resistance value, so high-pressure washing methods cannot be used.

The present invention has been devised in light of this situation, and the objective thereof lies in providing a vehicle painting machine which enables better washing of ducts inside an inkjet-type painting head, even under a low pressure.

### Means for Solving the Problems

A vehicle painting machine according to one aspect of the present invention comprises: an inkjet-type painting head having a plurality of nozzles for ejecting a paint and also comprising a head flow path for supplying the paint to the nozzles; a supply line for supplying the paint toward the painting head; a bypass flow path which causes the paint inside the supply line to bypass the painting head and flow to a downstream side of the painting head; a switching unit for switching a state of supply of the paint from the supply line between the head flow path and the bypass flow path; a supply unit for selectively supplying a washing liquid and air to the supply line; and a washing control unit for controlling the switching unit and the supply unit to wash the painting head, and the washing control unit washes the painting head with the washing liquid in a gas-liquid mixed state by supplying the air in a state in which the switching unit is switched to a state of supply to the bypass flow path wherein the supply line is filled with the washing liquid, and causing the washing liquid to flow to the head flow path by switching the switching unit to the state of supply to the head flow path in a state in which the air and the washing liquid have formed two layers along a flow direction.

### Effects of the Invention

The present invention makes it possible to provide a vehicle painting machine which enables better washing of ducts inside an inkjet-type coating head, even under a low pressure.

### BRIEF DESCRIPTION OF THE DRAWINGS

FIG. 1 is a schematic configuration diagram showing a painting robot of a vehicle painting machine according to the embodiment.

FIG. 2 is a circuit diagram showing a portion of a paint circulation pathway of the vehicle painting machine according to the embodiment.

FIG. 3 is a flowchart showing a washing process in the paint circulation pathway of the vehicle painting machine according to the embodiment.

FIG. 4 is an explanatory diagram to illustrate a mechanism by which a gas-liquid mixed state of the washing liquid is produced.

FIG. 5 is a circuit diagram showing a portion of the paint circulation pathway of the vehicle painting machine according to the embodiment, and shows a state in which a bypass flow path is open.

FIG. 6 is a circuit diagram showing a portion of the paint circulation pathway of the vehicle painting machine according to the embodiment, and shows a state in which head flow paths are open.

### DETAILED DESCRIPTION

### Embodiment of the Invention

A vehicle painting machine 10 according to the embodiment will be described below with reference to the drawings.

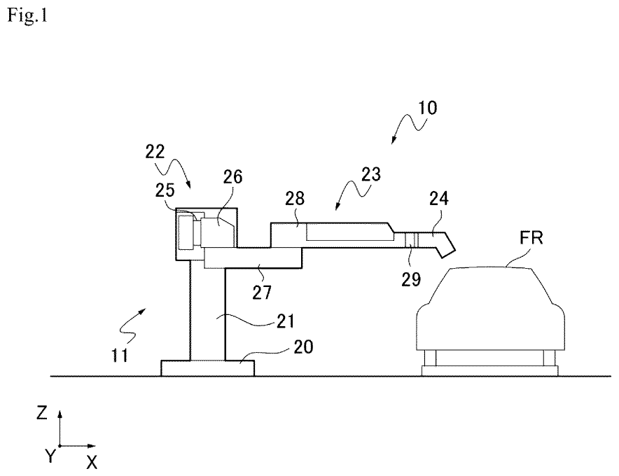

FIG. 1 is a schematic configuration diagram showing a painting robot 11 of a vehicle painting machine 10 according to the embodiment. The painting robot 11 is arranged in the vicinity of a painting line in an automobile production plant and paints vehicle bodies FR which are conveyed along the painting line. The vehicle body FR of an automobile is described as an example of an object being painted in the embodiment, but the object being painted may equally be an object other than the vehicle body FR of an automobile.

### [Painting Robot]

The painting robot 11 paints the vehicle body FR which is conveyed on the painting line from an upstream side. In a painting process, the vehicle body FR may be painted as it moves along the painting line, or the flow of the line may be stopped at a predetermined position to paint the vehicle body FR. The vehicle body FR which has been painted by means of the painting robot 11 is conveyed toward a downstream side of the painting line.

In the embodiment, the painting robot 11 is described as an example of an apparatus for painting the vehicle body FR, but the apparatus need not be the painting robot 11, provided that it comprises a paint circulation pathway 30 which will be described later. Furthermore, the painting robot 11 is depicted, by way of example, as having a painting head unit 24 capable of pivoting in directions centred on three axes, namely an X axis, a Y axis and a Z axis, but the painting head unit 24 may pivot about any one of the X axis, Y axis and Z axis, or may pivot about two of those axes.

The painting is carried out for the purpose of forming a paint film on a surface of the object being painted, in order to protect the surface and to impart an attractive appearance. The painting process may involve simply painting using a paint having a specific colour or a paint having a specific function, but also includes successively overcoating paints having multiple colours or paints having specific functions.

The painting robot 11 is illustrated as a multi-joint robot, but may equally be a SCARA robot, provided that it is capable of painting. As shown in FIG. 1, the painting robot 11 comprises: a stand 20, a leg portion 21, a rotational drive unit 22, a robot arm 23, and the painting head unit 24.

The stand 20 is a fixing member for fixing the painting robot 11 to a floor surface of the painting line and supporting the painting robot 11. The stand 20 may be movable over the floor surface of the painting line.

The leg portion 21 has a lower portion fixed to the stand 20 and an upper portion connected to the rotational drive unit 22, and extends to a vertical height suitable for painting to be performed by the painting robot 11.

The rotational drive unit 22 is connected to an upper end of the leg portion 21 and comprises a rotary shaft portion 25 and a rotating arm 26. The rotary shaft portion 25 causes the rotating arm 26 to rotate by means of a motor (not depicted) about a direction parallel to the floor surface (the X axis direction shown in FIG. 1). The rotating arm 26 causes the robot arm 23 connected to the rotating arm 26 to rotate with a straight line orthogonal to the centre of rotation of the rotary shaft portion 25 (the Z axis direction shown in FIG. 1) serving as a rotational centre.

The robot arm 23 comprises a first pivoting arm 27 and a second pivoting arm 28. The first pivoting arm 27 is connected to the rotating arm 26 at one end portion and connected to the second pivoting arm 28 at another end portion. The first pivoting arm 27 is pivoted by means of a motor (not depicted) mounted on the rotating arm 26, with the Z axis direction shown in FIG. 1 serving as a centre of pivoting. The second pivoting arm 28 is connected to the first pivoting arm 27 at one end portion and has a wrist portion 29 (to be described later) at another end portion. The second pivoting arm 28 is pivoted by means of a motor (not depicted), with the Z axis direction shown in FIG. 1 serving as a centre of pivoting.

The painting head unit 24 is disposed on the far tip end side of the painting robot 11 and sprays the vehicle body FR of the automobile with paint. The wrist portion 29 is held between the painting head unit 24 and the second pivoting arm 28. The wrist portion 29 causes the painting head unit 24 to pivot about at least one of the three axes (X axis, Y axis and Z axis) shown in FIG. 1.

The painting head unit 24 internally comprises a paint circulation pathway 30 for spraying paint from the painting head, and sprays the vehicle body FR moving over the painting line with paint at a suitable timing.

### [Paint Circulation Pathway]

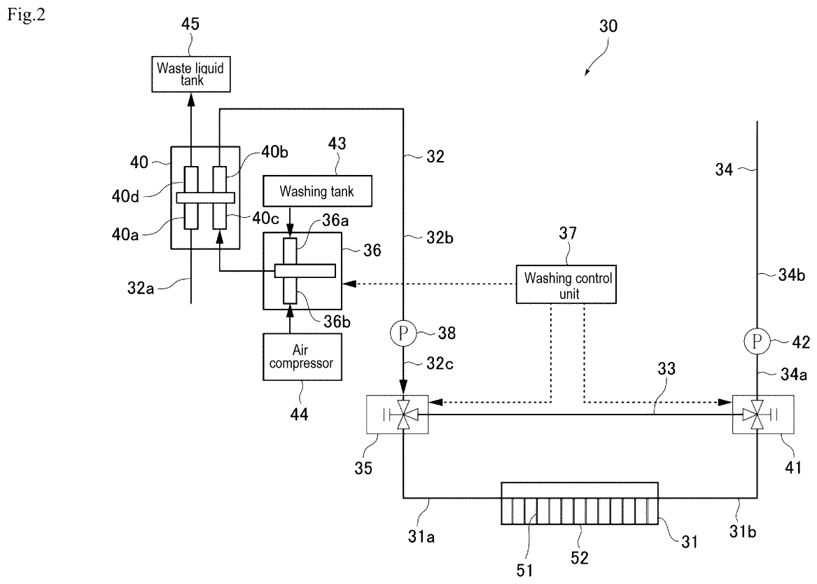

The paint circulation pathway 30 of the vehicle painting machine 10 will be described next with reference to FIG. 2. FIG. 2 is a circuit diagram showing a portion of the paint circulation pathway 30 of the vehicle painting machine 10 according to the embodiment.

The paint circulation pathway 30 comprises: a painting head 31, a supply line 32, a bypass flow path 33, a return flow path 34, a first three-way valve 35, a supply valve 36, and a washing control unit 37.

The paint circulation pathway 30 constitutes a circulation circuit for supplying paint stored in a paint tank (not depicted) to the painting head 31 via the supply line 32 when the vehicle body FR is being painted, and for returning the paint which was not used by the painting head 31 to the paint tank via the return flow path 34. Furthermore, the paint circulation pathway 30 also functions as a circulation circuit for returning the paint stored in the paint tank from the supply line 32 by way of the bypass flow path 33 to the paint tank via the return flow path 34, when the vehicle body FR is not being painted.

Here, a direction of supply of the paint in the supply line 32 is described in terms of a paint tank side, which is the upstream side, and a painting head 31 side, which is the downstream side. Furthermore, the direction of supply of the paint in the return flow path 34 is described in terms of the painting head 31 side, which is the upstream side, and the paint tank side, which is the downstream side.

The paint is a water-based paint or a solvent-based paint employing a pigment. By circulating the paint inside the paint circulation pathway 30, it is therefore possible to prevent situations in which the pigment contained in the paint separates or coagulates inside the paint circulation pathway 30, while also enabling the viscosity of the paint to be reduced.

The painting head 31 is an inkjet-type head having a nozzle-forming face 52 with an array of multiple nozzles 51, and forms a paint film on a surface of the vehicle body FR by ejecting the paint supplied via the supply line 32 from each of the multiple nozzles 51. Nozzle rows (not depicted) are formed by a predetermined number of nozzles 51, and the nozzle rows are provided diagonally in relation to a scanning direction, which is a direction of movement of the painting head 31, but the nozzle rows may equally be provided so as to follow the scanning direction or lie orthogonal thereto. Note that the detailed configuration of the painting head 31 is omitted.

The supply line 32 is a flow path for supplying the paint stored in the paint tank toward the painting head 31. The supply line 32 is divided into sections of different flow paths 32a, 32b, 32c by a plurality of components installed along the supply line 32. The paint inside the supply line 32 is pumped by means of a first gear pump 38 installed partway along the supply line 32. The supply line 32 comprises, in succession from the upstream side, a switching valve 40, the first gear pump 38, and the first three-way valve 35 serving as a switching unit.

The first three-way valve 35 is connected to a downstream end of the first gear pump 38 in the supply line 32. When the vehicle body FR is being painted by the painting head 31, the first three-way valve 35 maintains a state of communication between the flow path 32c and a head flow path 31a in which the painting head 31 is provided. When the vehicle body FR is not being painted by the painting head 31, the first three-way valve 35 switches to a state of communication between the flow path 32c and the bypass flow path 33. Note that the upstream side of the flow path 32c is connected to the first gear pump 38 while the downstream side is connected to the first three-way valve 35.

The bypass flow path 33 connects the first three-way valve 35 and a second three-way valve 41 (to be described later), and causes the paint supplied from the supply line 32 to flow back to the return flow path 34 while bypassing the painting head 31 when painting is not being performed by the painting head 31.

The return flow path 34 is a flow path for causing the paint which was not used by the painting head 31 or the paint circulating in the paint circulation pathway 30 to flow toward the downstream side of the return flow path 34, which is the upstream side of the supply line 32, in order to return this paint to the paint tank. The return flow path 34 is divided into sections of different flow paths 34a, 34b by a plurality of components installed along the return flow path 34. The paint inside the return flow path 34 is pumped by means of a second gear pump 42 installed partway along the return flow path 34. The return flow path 34 comprises, in succession from the upstream side, the second three-way valve 41 and the second gear pump 42. Note that the upstream side of the flow path 34a is connected to the second three-way valve 41 while the downstream side is connected to the second gear pump 42. Furthermore, the upstream side of the flow path 34b is connected to the second gear pump 42 while the downstream side is connected to the paint tank (not depicted).

The second three-way valve 41 is connected to a downstream end of a head flow path 31b. When the vehicle body FR is being painted by the painting head 31, the second three-way valve 41 maintains a state of communication between the head flow path 31b and the flow path 34a. Furthermore, when the vehicle body FR is not being painted by the painting head 31, the second three-way valve 41 switches to a state of communication between the bypass flow path 33 and the flow path 34a. The second gear pump 42 draws in paint flowing through the flow path 34a and pumps this paint to the flow path 34b connected to the downstream side of the second gear pump 42.

The supply line 32 has a switching valve 40 on the upstream side of the first gear pump 38. The switching valve 40 is connected to a downstream end of the flow path 32a. The switching valve 40 has four valve units 40a, 40b, 40c, 40d. The valve unit 40a is connected to the flow path 32a on the upstream side, and the valve unit 40b is connected to the flow path 32b on the downstream side. Accordingly, the valve unit 40a and the valve unit 40b are opened so that paint from the flow path 32a flows toward the flow path 32b when paint is being supplied from the paint tank toward the painting head 31 or when paint is being circulated.

The switching valve 40 is connected to the supply valve 36 which serves as a supply unit. The supply valve 36 is connected to the valve unit 40c of the switching valve 40 and can selectively switch a valve unit 36a capable of conducting a washing liquid supplied from a washing tank 43, and a valve unit 36b capable of conducting air supplied from an air compressor 44. When the valve unit 36a or the valve unit 36b is open during washing, the washing liquid or air therefore selectively flows to the downstream side of the supply line 32.

The valve unit 40d is connected to a waste liquid tank 45. If the valve unit 40a and the valve unit 40d are opened when the supply line 32 has been washed upstream of the switching valve 40 separately from the washing operation of the embodiment, the washing liquid and air flowing through the flow path 32a which is connected to the open valve unit 40a therefore flow to the waste liquid tank 45 via the valve unit 40d.

The washing control unit 37 washes the painting head 31 by switching the supply valve 36, the first three-way valve 35, and the second three-way valve 41 in a state in which the valve unit 40c and the valve unit 40b of the switching valve 40 are connected.

### [Painting Head Washing Process]

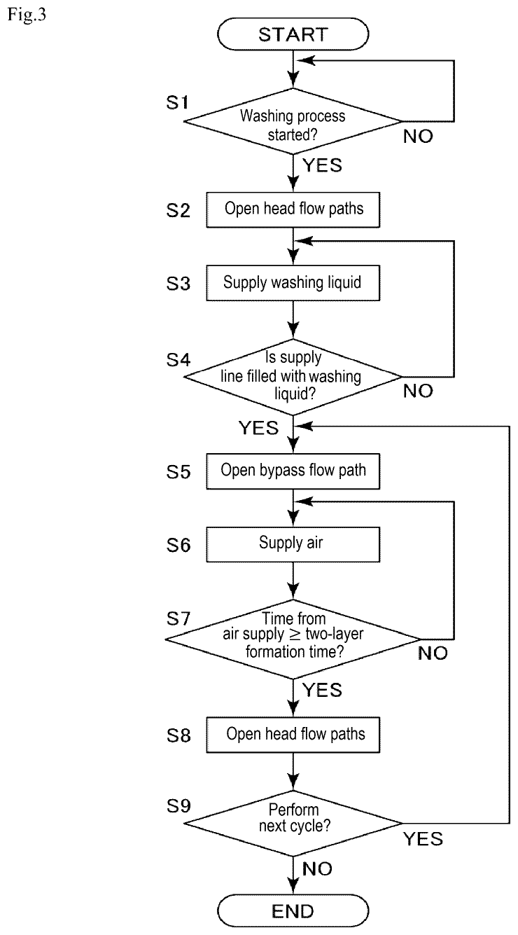

Washing of the painting head 31 by means of the washing control unit 37 will be described with reference to FIG. 3. FIG. 3 is a flowchart showing the process of washing the painting head 31 of the vehicle painting machine 10 according to the embodiment.

In step S1, the washing control unit 37 determines whether or not the process of washing the painting head 31 has started. If it is determined that the washing process has started, the processing advances to step S2, and if it is not determined that the washing process has started, step S1 is again repeated. A control unit (not depicted) in the paint circulation pathway 30 determines that the washing process is to be performed.

In step S2, the washing control unit 37 opens the head flow paths 31a, 31b. In order to open the head flow paths 31a, 31b, the washing control unit 37 switches the first three-way valve 35 to establish a state of communication between the flow path 32c and the head flow path 31a in which the painting head 31 is provided on the downstream side, and also switches the second three-way valve 41 to establish a state of communication between the head flow path 31b in which the painting head 31 is provided on the upstream side and the flow path 34a.

In step S3, the washing control unit 37 supplies the washing liquid to the supply line 32. The first gear pump 38 and the second gear pump 42 are driven in a state in which the valve unit 36a of the supply valve 36 is open and the valve units 40b, 40c of the switching valve 40 are open, whereby the washing liquid supplied from the washing tank 43 is supplied to the supply line 32.

In step S4, the washing control unit 37 determines whether or not the supply line 32 has been filled with the washing liquid. If it is determined that the supply line 32 has been filled with the washing liquid, the processing advances to step S5, and if it is not determined that the supply line has been filled with the washing liquid, the processing returns to step S3 and filling with the washing liquid is continued.

It is possible to determine whether or not the supply line 32 has been filled with the washing liquid by experimentation, etc. in advance to obtain the internal volume of the flow path running from the washing tank 43 to the first three-way valve 35 disposed at the upstream end of the painting head 31, or this determination may be made according to the time elapsed from the washing liquid starting to flow.

In step S5, the washing control unit 37 opens the bypass flow path 33. The washing control unit 37 switches the first three-way valve 35 to establish a state of communication between the flow path 32c and the bypass flow path 33, and also switches the second three-way valve 41 to establish a state of communication between the bypass flow path 33 and the flow path 34a. The bypass flow path 33 is opened as a result, and the washing liquid flows to the bypass flow path 33 without flowing to the painting head 31.

In step S6, the washing control unit 37 supplies air to the supply line 32. Air supplied from the air compressor 44 is supplied to the supply line 32 by switching the supply valve 36 to open the valve unit 36b. Here, the volume of air which is supplied is smaller than the volume of washing liquid previously supplied in step S3, and is set at around 10% of the volume of washing liquid, for example.

Furthermore, this embodiment employs an inkjet-type painting head 31, so the painting head 31 has relatively low performance in terms of pressure resistance. However the pressure of the air which is supplied in this step S6 needs to be set somewhat higher than the pressure-resistance value of the pressure head 31 in order to subsequently form two layers with the washing liquid. Nonetheless, since the volume of air is sufficiently smaller than the volume of washing liquid, as indicated above, the overall pressure is lower than the pressure-resistance value of the painting head 31 if the air mixes with the washing liquid to form a gas-liquid mixed state, and the painting head 31 is therefore not adversely affected by the level of air pressure.

In step S7, the washing control unit 37 determines whether or not the time elapsed from the supply of air starting has reached or passed a predetermined two-layer formation time. If it is determined that the time elapsed from the supply of air starting has reached or passed the two-layer formation time, the processing advances to step S8, and if it is not determined that this time has reached or passed the two-layer formation time, the processing returns to step S6 and the supply of air is continued.

The predetermined two-layer formation time, which is obtained in advance by experimentation, etc., is the time required until the washing liquid and the air inside the supply line 32 form two layers along the flow direction as a result of air being supplied into the supply line 32 while the washing liquid is flowing to the bypass flow path 33 side.

In step S8, the washing control unit 37 opens the head flow paths 31a, 31b of the painting head 31. The washing control unit 37 switches the first three-way valve 35 to establish a state of communication between the flow path 32c and the head flow path 31a, and also switches the second three-way valve 41 to establish a state of communication between the head flow path 31b and the flow path 34a. The head flow paths 31a, 31b are opened as a result.

By opening the head flow paths 31a, 31b, the washing liquid and air forming two layers inside the supply line 32 flow into the head flow paths 31a, 31b. At this time, since the volume of air is sufficiently smaller than the volume of washing liquid, the air is pushed into the head flow paths 31a, 31b by the washing liquid so as to produce a gas-liquid mixed state in which the air is mixed into the washing liquid. The washing liquid in the gas-liquid mixed state flows through the head flow paths 31a, 31b, thereby enabling better washing inside the flow paths as compared to when only the washing liquid flows.

Furthermore, although the pressure of the air is set at a higher pressure than the pressure-resistance value of the painting head 31 in step S6, the pressure of the air in the washing liquid in the gas-liquid mixed state is lower than the pressure-resistance value of the painting head 31, and the painting head 31 can therefore be washed without being damaged.

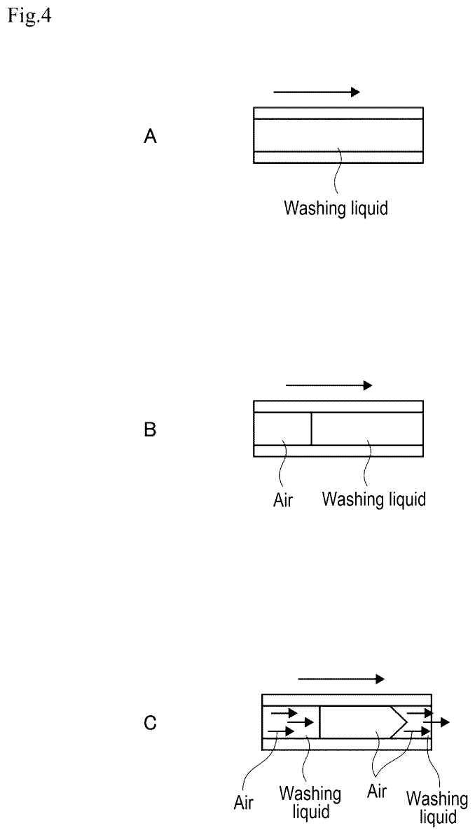

Here, the mechanism by which the washing liquid reaches a gas-liquid mixed state will be described with reference to FIG. 4. FIG. 4 is an explanatory diagram to illustrate the mechanism by which the gas-liquid mixed state of the washing liquid is produced.

The supply line 32 is filled with the washing liquid, after which air in a smaller volume than the washing liquid is supplied into the supply line 32 while the washing liquid inside the supply line 32 is flowing to the bypass line 33 (FIG. 4A). When the predetermined two-layer formation time has elapsed from the air being supplied, the air and the washing liquid inside the supply line 32 are formed in a two-layer state (FIG. 4B). When the flow path is switched from the bypass flow path 33 to the head flow paths 31a, 31b in this state, the air is pushed into the head flow paths 31a, 31b by the washing liquid, producing a gas-liquid mixed state of the washing liquid (FIG. 4C).

The volume of washing liquid in the gas-liquid mixed state varies according to the volume of air introduced in step S6, but since the volume of air is sufficiently smaller than the volume of washing liquid, the volume of washing liquid in the gas-liquid mixed state is also relatively small. The washing liquid in the gas-liquid mixed state therefore flows through the head flow paths 31a, 31b and then returns to washing liquid not containing air, so the inside of the supply line 32 is once again filled with washing liquid (FIG. 4A).

Returning to FIG. 3, in step S9, the washing control unit 37 determines whether or not to again repeat the washing cycle, where the washing liquid in the gas-liquid mixed state is made to flow into the head flow paths 31a, 31b, which was performed in steps S5 to S8 of the process of washing the head flow paths 31a, 31b of the painting head 31 which was performed over steps S2 to S8. If it is determined that the washing cycle is to be repeated, the processing returns to step S5, and if it is not determined that the washing cycle is to be repeated, the processing ends.

### [Washing Cycle]

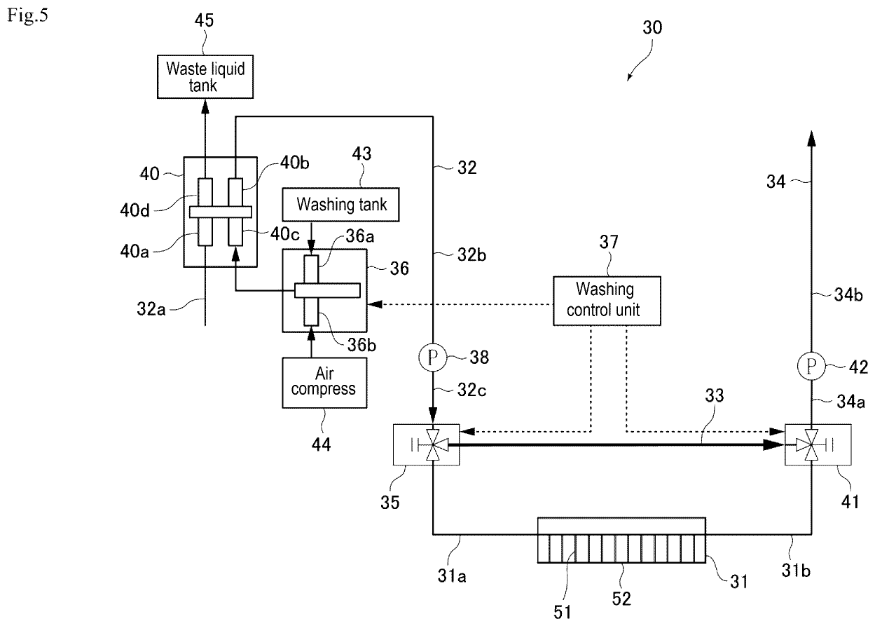

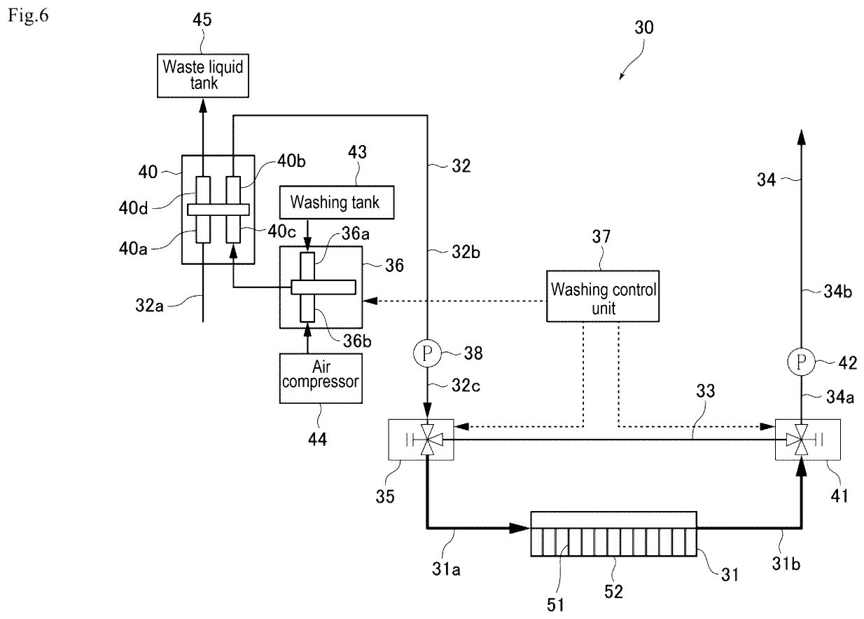

The cycle of washing the head flow paths 31a, 31b of the painting head 31 will be described next with reference to FIGS. 5 and 6. FIG. 5 is a circuit diagram showing a portion of the paint circulation pathway 30 of the vehicle painting machine 10 according to the embodiment, and shows a state in which the bypass flow path 33 is open. FIG. 6 is a circuit diagram showing a portion of the paint circulation pathway 30 of the vehicle painting machine 10 according to the embodiment, and shows a state in which the head flow paths 31a, 31b are open.

As shown in FIG. 5, air is supplied to the supply line 32 when the washing liquid supplied from the supply line 32 is flowing through the bypass flow path 33, and the flow path is switched to the head flow paths 31a, 31b once the air and the washing liquid inside the supply line 32 are formed into two layers.

When this happens, as shown in FIG. 6, the air is pushed in by the washing liquid so that washing liquid in the gas-liquid mixed state flows through the head flow paths 31a, 31b. At this time, the inside of the head flow paths 31a, 31b is washed by the washing liquid in the gas-liquid mixed state with higher washing performance than washing with washing liquid alone.

After this, the flow path is once again switched to the bypass flow path 33, as shown in FIG. 5, and when the air and the washing liquid inside the supply line 32 are once again formed into two layers, the flow path is switched to the head flow paths 31a, 31b so that the washing liquid in the gas-liquid mixed state is made to flow to the head flow paths 31a, 31b, as shown in FIG. 6. One washing cycle thus runs from a state in which the flow path is switched to the bypass flow path 33 and the air and the washing liquid are formed into two layers (FIG. 5) to a state in which the flow path is switched to the head flow paths 31a, 31b so that the washing liquid in the gas-liquid mixed state is made to flow to the head flow paths 31a, 31b (FIG. 6), and this washing cycle is repeated for the number of cycles required to wash the head flow paths 31a, 31b.

### Variant Example

In the embodiment above, the bypass flow path and the head flow paths are switched by using the first three-way valve 35 and the second three-way valve 41, but other valves may be used provided that they are capable of reliably switching flow path.

Furthermore, in the embodiment above, one supply valve 36 is switched to switch between ejection of washing liquid and air, but a washing liquid discharge valve and an air discharge valve may be independently provided and these two discharge valves may be selectively controlled to open and close.

Furthermore, in the embodiment above, the washing control unit 37 was described as an independent control unit, but it may equally be incorporated into a control unit for controlling the switching valve 40, the first gear pump 38 and the second gear pump 42 in order to perform integrated control.

### Supplementary Description of Embodiments

The embodiments described above all merely illustrate preferred specific examples of the present invention. The numerical values, components, and arrangement locations and ordering of connection configurations of the components, etc. which are given in the embodiments above are merely examples and are not intended to limit the present invention. Furthermore, the drawings are not necessarily strict depictions.

Embodiments of the present invention were described above, but those embodiments merely illustrate some examples of application of the present invention, and are not intended to limit the technical scope of the present invention to the specific configurations of the embodiments.

The series of processes described above may also be implemented by means of hardware, or may also be implemented by means of software. When the series of processes are implemented by means of software, a program constituting the software is installed from a program recording medium onto a computer incorporated into dedicated hardware, or onto a general-purpose computer, etc. capable of implementing various functions by installing various programs, or similar.

Note that the program run by the computer may be a program that performs processing in time series in the sequence described in this specification, or may be a program that performs processing in parallel or at the required timing, such as when called up.

### [Additional Notes]

Details of the disclosure of the several embodiments described above will be understood as follows, for example.

### (1) Flow of Washing Liquid in a Gas-Liquid Mixed State to the Head Flow Path

A vehicle painting machine 10 comprises: an inkjet-type painting head 31 having a plurality of nozzles 51 for ejecting a paint and also comprising a head flow path 31a for supplying the paint to the nozzles 51; a supply line 32 for supplying the paint toward the painting head 31; a bypass flow path 33 which causes the paint inside the supply line 32 to bypass the painting head 31 and flow to a downstream side of the painting head 31; a first three-way valve 35 for switching a state of supply of the paint from the supply line 32 between the head flow paths 31a, 31b and the bypass flow path 33; a supply valve 36 for selectively supplying a washing liquid and air to the supply line 32; and a washing control unit 37 for controlling the first three-way valve 35 and the supply valve 36 to wash the painting head 31, and the washing control unit 37 washes the painting head 31 with the washing liquid in a gas-liquid mixed state by supplying the air in a state in which the first three-way valve 35 is switched to a state of supply to the bypass flow path 33 wherein the supply line 32 is filled with the washing liquid, and causing the washing liquid to flow to the head flow paths 31a, 31b by switching the first three-way valve 35 to the state of supply to the head flow paths 31a, 31b in a state in which the air and the washing liquid have formed two layers along a flow direction.

By this means, the washing liquid is supplied to the bypass flow path 33 with the supply line 32 having been filled with the washing liquid, and once the air and washing liquid have formed two layers, the flow path is switched to the head flow paths 31a, 31b and washing liquid in the gas-liquid mixed state can be formed. The painting head 31 can therefore be better washed without using a washing liquid containing high-pressure compressed air or microbubbles generated by high pressure, even in the case of the vehicle painting machine 10 which comprises the inkjet-type painting head 31 which structurally has a low pressure-resistance value.

### (2) Timing of Flow to the Head Flow Path

The washing control unit 37 may switch the state of supply of the paint from the supply line 32 to the head flow paths 31a, 31b when the air and the washing liquid have formed two layers in the supply line 32.

By this means, the air is pushed into the head flow paths 31a, 31b by the washing liquid, making it possible to form a washing liquid in the gas-liquid mixed state in which the air is mixed into the washing liquid. The washing liquid can therefore demonstrate adequate washing performance inside the head flow paths 31a, 31b.

### (3) Determination of the Time of the Gas-Liquid Mixed State

The washing control unit 37 may determine that the air and the washing liquid have formed two layers in the supply line 32 when a predetermined two-layer formation time has elapsed from the air being initially supplied to the supply line 32.

By this means, it is possible to determine by time that the washing liquid and the air have formed two layers inside the supply line 32, and it is therefore possible to accurately predict that a state has been reached where a gas-liquid mixed state can be formed by the flow of washing liquid into the head flow paths 31a, 31b by obtaining this time in advance by means of experimentation etc.

Furthermore, it is also possible to prevent a delay in time until washing is started due to the flow path to the head flow paths 31a, 31b not being switched despite the air and the washing liquid forming two layers in the supply line 32.

### (4) Air<Washing Liquid

A supply amount of the air to the supply line 32 by means of the supply valve 36 controlled by the washing control unit may be smaller than a supply amount of the washing liquid.

By this means, it is possible to prevent actual air from being fed to the head flow paths 31a, 31b because of a state of inadequate gas-liquid mixing when the flow path through which the washing liquid flows is switched from the bypass flow path 33 to the head flow paths 31a, 31b, and to prevent high-pressure air from being fed to the painting head 31 which has a low pressure-resistance value.

Furthermore, actual air can be fed to the nozzles 51 so that non-ejection of paint from the nozzles 51 after the end of washing can be prevented.

### KEY TO SYMBOLS

10 Vehicle painting machine
31 Painting head
31a Head flow path
31b Head flow path
32 Supply line
33 Bypass flow path
35 First three-way valve (switching unit)
36 Supply valve (supply unit)
37 Washing control unit
51 Nozzle

1. A vehicle painting machine comprising:
an inkjet-type painting head having a plurality of nozzles for ejecting a paint and also comprising a head flow path for supplying the paint to the nozzles;
a supply line for supplying the paint toward the painting head;
a bypass flow path which causes the paint inside the supply line to bypass the painting head and flow to a downstream side of the painting head;
a switching unit for switching a state of supply of the paint from the supply line between the head flow path and the bypass flow path;
a supply unit for selectively supplying a washing liquid and air to the supply line; and
a washing control unit for controlling the switching unit and the supply unit to wash the painting head,
wherein the washing control unit washes the painting head with the washing liquid in a gas-liquid mixed state by supplying the air in a state in which the switching unit is switched to a state of supply to the bypass flow path wherein the supply line is filled with the washing liquid, and causing the washing liquid to flow to the head flow path by switching the switching unit to the state of supply to the head flow path in a state in which the air and the washing liquid have formed two layers along a flow direction.

2. The vehicle painting machine according to claim 1, wherein the washing control unit switches the state of supply of the paint from the supply line to the head flow path when the air and the washing liquid have formed two layers in the supply line.

3. The vehicle painting machine according to claim 2, wherein the washing control unit determines that the air and the washing liquid have formed two layers in the supply line when a predetermined two-layer formation time has elapsed from the air being initially supplied to the supply line.

4. The vehicle painting machine according to claim 1, wherein a supply amount of the air to the supply line by means of the supply unit controlled by the washing control unit is smaller than a supply amount of the washing liquid.
